(19) United States
(12) Patent Application Publication
(10) Pub. No.: US 2012/0043311 A1
(43) Pub. Date: Feb. 23, 2012

(54) PORCELAIN-ENERGY HEATER

(75) Inventor: Binglin ZHONG, Guangzhou (CN)

(73) Assignee: KUKEL PORCELAIN-ENERGY TECHNOLOGY LIMITED, Yumatei (HK)

(21) Appl. No.: 12/984,892

(22) Filed: Jan. 5, 2011

(30) Foreign Application Priority Data
Aug. 17, 2010 (CN) 201010256682.4

(51) Int. Cl. H05B 3/10

(52) U.S. Cl. 219/553

(57) ABSTRACT

A porcelain-energy heater includes a heat source for producing heat and an insulation material enclosing the heat source therein. The insulation material may be made of a porcelain material.

### TECHNICAL FIELD

The disclosure relates to ohmic heating and, more particularly, to a porcelain-energy heater.

### BACKGROUND

Electrical environment has been greatly improved in recent years following the deep reconstruction of city power grid. Instant electric water heaters are gradually becoming popular to more and more consumers because of its lightness, rapid hot water delivery and convenience to use. Since the instant electric water heater operates with electricity during use, its safety is of particular concern. The safety performance of its core part—insulation material—is thus a determining factor for the safety of the instant electric water heater. The insulation materials currently used in the market mainly include copper pipe insulation material, stainless steel insulation material, aluminum alloy insulation material, glass insulation material, quartz tube, crystal insulation material or the like. However, each of these insulation materials has its own shortcomings, either having poor stability in performance, high energy consumption, low safety factor, low thermal efficiency, short life, large size, or being too expensive for consumers to accept. The same issues will be encountered when the traditional insulation materials or devices are used in various fields, such as, in industrial use, mechanical manufacturing field, or in heating applications where a fluid or solid is needed.

Currently, there are mainly two types of insulation materials, i.e. metal and non-metal materials.

Metal insulation material: Its outer part is stainless material, copper pipe material or the like and its inside heating tube is made of nickel-chromium alloy resistance wire. The inside heating tube is inserted into a cup-like container to heat water. Whether the stainless steel or the copper is used as the insulation material, the inherent defect of forming scale on the metal insulation materials may often lead to electricity leakage or fracture during use. No metal can avoid the scale formation which causes a reduction of heat conduction efficiency and increase in energy consumption. In addition, due to the big difference in the coefficient of expansion of the metal and scale, the metal tube breaks easily, which leaves a hidden danger of electricity leakage. Currently, electric heaters at home and abroad commonly adopt an electric heating manner in which an electric resistance wire is disposed in a metal tube and isolated from the metal tube by filling insulation powder therebetween, or an exposed heating manner in which the electric resistance wire is wound around the outside of an insulation material. For example, electric water heaters, electric hot pots, electric cookers, water dispensers, electric cups, electric irons, hairdryers, electric food warmers, disinfection cabinets, electric warmers, hot water heating systems for spa tubs, plastic press machines, phosphate pools for industrial use, and acid-alkali pools for thermal treatment that are currently commercially available all adopt the above heating manners.

Non-metal insulation material: The materials mainly include quartz tube, glass and crystal that are all insulative and are not easy to form scale. However, crystal is too expensive. Quartz and glass tubes are unstable under sudden cold and sudden hot conditions and can break easily. In addition, quartz and glass tubes have a fixed shape which prevents them from being widely used. In recent years, heaters including a PTC ceramic quartz tube have been used in warmers. However, they suffer from the common problems of short life, large size, low efficiency, high energy consumption, instability, poor safety.

Besides, there are also electromagnetic heating manner and microwave heating manner. However, heaters heating in these manners consume a lot of electricity, have a large size, and are limited by many conditions, such as, shape, space or the like. Moreover, heaters heating in these manners produce high level of radiation which may have harmful effects on human health when they are long-term used.

### SUMMARY

Generally, a porcelain-energy heater is described which includes a heat source and an insulation material enclosing the heat source therein. The insulation material may be made of a porcelain material. As used herein, the term “porcelain-energy” is intended to mean a heating manner in which the heat of a porcelain material is transferred to an object (e.g. water) to thereby heat the object.

In one embodiment, the porcelain material may include one or more of silicon nitride, titanium nitride, aluminum nitride, and aluminum oxide.

In one embodiment, the heat source may be made of alloy electric heating wire and/or tungsten wire, and the insulation material and the heat source may be joined by a hot-pressing sintering process

In one embodiment, the alloy electric heating wire may be made of nickel-chromium resistance wire.

In one embodiment, the heat source may include a plurality of sub-heat sources.

### DESCRIPTION OF THE DRAWING

FIG. 1 illustrates a general structure of a porcelain-energy heater.

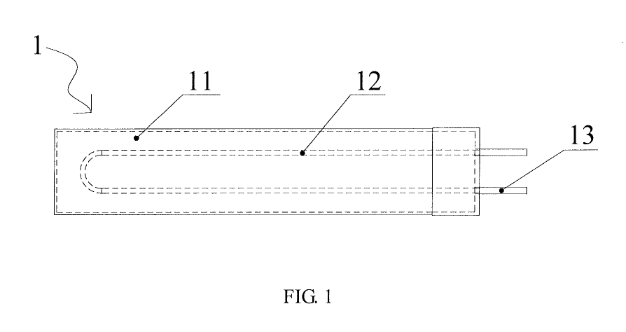

### DETAILED DESCRIPTION

### First Embodiment

In the first embodiment, the porcelain-energy heater 1 generally includes a heat source 12 and an insulation material 11 enclosing the heat source 12 therein. The heat source 12 is electrically connected with lead pins 13 for receiving electricity such that the heat source 12 can produce heat from electricity. The insulation material 11 is made of a porcelain material.

In this embodiment, the porcelain material of the insulation material 11 is silicon nitride (Si₃N₄). The heat source 12 is made of alloy electric heating wire and/or tungsten wire. One example of the alloy electric heat wire is nickel-chromium resistance wire. It should be understood, however, that the particular materials of the heat source 12 described herein are merely illustrative rather than limiting. Thus, the heat source 12 may be configured with any suitable material and/or into any suitable structure that can generate heat from electricity. In the illustrated embodiment, the insulation material 11 and the heat source 12 are joined by a hot-pressing sintering process. Therefore, the heat source 12 is directly contacted with the insulation material 11. It is noted, however, that the heat source 12 and the insulation material 11 could be joined by another suitable joining method in another embodiment.

### Second Embodiment

In the second embodiment, the porcelain-energy heater 1 generally includes a heat source 12 and an insulation material 11 enclosing the heat source 12 therein. The heat source 12 is electrically connected with lead pins 13 for receiving electricity such that the heat source 12 can produce heat from electricity. The insulation material 11 is made of a porcelain material.

In this embodiment, the porcelain material of the insulation material 11 is aluminum nitride (AlN). The heat source 12 is made of alloy electric heating wire and/or tungsten wire. One example of the alloy electric heat wire is nickel-chromium resistance wire. It should be understood, however, that the particular material of the heat source 12 described herein is merely illustrative rather than limiting. Thus, the heat source 12 may be configured with any suitable material and/or into any suitable structure that can generate heat from electricity. In the illustrated embodiment, the insulation material 11 and the heat source 12 are joined by a hot-pressing sintering process. Therefore, the heat source 12 is directly contacted with the insulation material 11. It is noted, however, that the heat source 12 and the insulation material 11 could be joined by another suitable joining method in another embodiment.

### Third Embodiment

In the third embodiment, the porcelain-energy heater 1 generally includes a heat source 12 and an insulation material 11 enclosing the heat source 12 therein. The heat source 12 is electrically connected with lead pins 13 for receiving electricity such that the heat source 12 can produce heat from electricity. The insulation material 11 is made of a porcelain material.

In this embodiment, the porcelain material of the insulation material 11 is titanium nitride (TiN). The heat source 12 is made of alloy electric heating wire and/or tungsten wire. One example of the alloy electric heat wire is nickel-chromium resistance wire. It should be understood, however, that the particular materials of the heat source 12 described herein are merely illustrative rather than limiting. Thus, the heat source 12 may be configured with any suitable material and/or into any suitable structure that can generate heat from electricity. In the illustrated embodiment, the insulation material 11 and the heat source 12 are joined by a hot-pressing sintering process. Therefore, the heat source 12 is directly contacted with the insulation material 11. It is noted, however, that the heat source 12 and the insulation material 11 could be joined by another suitable joining method in another embodiment.

### Fourth Embodiment

In the fourth embodiment, the porcelain-energy heater 1 generally includes a heat source 12 and an insulation material 11 enclosing the heat source 12 therein. The heat source 12 is electrically connected with lead pins 13 for receiving electricity such that the heat source 12 can produce heat from electricity. The insulation material 11 is made of a porcelain material.

In this embodiment, the porcelain material of the insulation material 11 is aluminum oxide (Al₂O₃). The heat source 12 is made of alloy electric heating wire and/or tungsten wire. One example of the alloy electric heat wire is nickel-chromium resistance wire. It should be understood, however, that the particular materials of the heat source 12 described herein are merely illustrative rather than limiting. Thus, the heat source 12 may be configured with any suitable material and/or into any suitable structure that can generate heat from electricity. In the illustrated embodiment, the insulation material 11 and the heat source 12 are joined by a hot-pressing sintering process. Therefore, the heat source 12 is directly contacted with the insulation material 11. It is noted, however, that the heat source 12 and the insulation material 11 could be joined by another suitable joining method in another embodiment.

### Fifth Embodiment

In the fifth embodiment, the porcelain-energy heater 1 generally includes a heat source 12 and an insulation material 11 enclosing the heat source 12 therein. The heat source 12 is electrically connected with lead pins 13 for receiving electricity such that the heat source 12 can produce heat from electricity. The insulation material 11 is made of a porcelain material.

In this embodiment, the porcelain material of the insulation material 11 includes at least two of silicon nitride (Si₃N₄), titanium nitride (TiN), aluminum nitride (AlN) and aluminum oxide (Al₂O₃). The heat source 12 is made of alloy electric heating wire and/or tungsten wire. One example of the alloy electric heat wire is nickel-chromium resistance wire. It should be understood, however, that the particular materials of the heat source 12 described herein are merely illustrative rather than limiting. Thus, the heat source 12 may be configured with any suitable material and/or into any suitable structure that can generate heat from electricity. In the illustrated embodiment, the insulation material 11 and the heat source 12 are joined by a hot-pressing sintering process. Therefore, the heat source 12 is directly contacted with the insulation material 11. It is noted, however, that the heat source 12 and the insulation material 11 could be joined by another suitable joining method in another embodiment.

### Sixth Embodiment

In the sixth embodiment, the porcelain-energy heater 1 generally includes a heat source 12 and an insulation material 11 enclosing the heat source 12 therein. The heat source 12 is electrically connected with lead pins 13 for receiving electricity such that the heat source 12 can produce heat from electricity. The insulation material 11 is made of a porcelain material.

In this embodiment, the porcelain material of the insulation material 11 can be any material described in the previous embodiments or any combination thereof. The heat source 12 can also be made of any material described in the previous embodiments or any combination thereof. In the illustrated embodiment, the insulation material 11 and the heat source 12 are joined by a hot-pressing sintering process. Therefore, the heat source 12 is directly contacted with the insulation material 11. It is noted, however, that the heat source 12 and the insulation material 11 could be joined by another suitable joining method in another embodiment. In this embodiment, the heat source 12 comprises a plurality of sub-heat sources for more uniform heat transfer. That is, the plurality of sub-heat sources collectively forms the heat source 12. Each sub-heat source may be directly contacted with the insulation material.

As described above, a porcelain material is used as the insulation material for the porcelain-energy heater. The porcelain material can be silicon nitride (Si₃N₄), aluminum nitride (AlN), titanium nitride (TiN), aluminum oxide (Al₂O₃) or any combination thereof. During use, the heat produced by the heat source from electricity is conducted to the porcelain material which in turn transfers the heat to the object, for example, water, as described in this disclosure, thus heating the water.

In these embodiments described above, the porcelain-energy heater has only one insulation material isolating the heat source, thereby reducing the energy loss during heat transfer, reducing the possibilities of electric leakage due to heater fracture, increasing the safety, as well as prolonging the product life. It is noted, however, that the present invention is not intended to be limited the particular embodiments described herein.

In comparison with the conventional heaters, the porcelain-energy heater described herein has at least one of the following advantages:
1. Improved safety and reliability: The silicon nitride (Si₃N₄), titanium nitride (TiN), aluminum nitride (AlN) and aluminum oxide (Al₂O₃) of the porcelain-energy heater are insulating materials and have a leakage current of 0.052 mA, which completely complies with the leakage current requirement of common home appliances (required to be less than 0.25 mA). A safety test conducted in the water shows that, when a porcelain-energy heater accidentally breaks during working in the water under a supply voltage of 220V, the voltage of the water is lower than 36V and the leakage impedance is higher than 300KΩ, which is not high enough to cause an electric shock injury. In addition, the porcelain-energy heater can be used with voltages ranging from 6V-380V.
2. No water scale: The heater is the “heart” of an electric water heater and the water scale significantly affects the use of the water heater. In particular, a large part of the area in China belongs to high water-scale level region, where water heater incidents due to water scale frequently happen. The technique used in the porcelain-energy heater can solve the safety issue arising from water heat scale fundamentally.
3. Energy-saving, environmentally friendly, and high energy utilization rate: The porcelain-energy heater consuming electrical power does not produce exhaust gases and utilizes public power and, therefore, can be considered as a low carbon component. Regarding the energy utilization rate, the stainless steel heaters currently used in the industry have a thermal efficiency of at most 80%-90%, while the porcelain-energy heater described herein can achieve a thermal efficiency of more than 98%, which saves energy effectively.
4. When used in a water heater, the porcelain-energy heater produces a very tiny electromagnetic effect such that, when the heater transfers heat to the water passing by, the water is magnetized by the very tiny electromagnetic field at the same time. Regularly bathing or washing face with magnetized water has various benefits such as beauty and health maintenance, and long life. When the porcelain-energy heater is used in a hot water system of a water dispenser, drinking magnetized water can help keep healthy. When the porcelain-energy heater is used in a hot water system of a washing machine, the amount of detergent can be effectively reduced because the water can be softened by the magnetic field, which protects the environment as well as reduces cost.
5. High temperature resistant: The porcelain-energy heater can work for a long time at 1200□ temperature.
6. Erosion-resistant: Six-hour boiling tests show that an average erosion rate of the porcelain-energy heater in 30% sodium hydroxide (NaOH) solution is 0.43 g/m2h and the average erosion rate of the porcelain-energy heater in 5% sulfuric acid (H₂SO₄) Solution is 9.21 g/m2h. In contrast, the erosion rate of stainless steel under the same environment is 81˜121 g/m2h. Therefore, the porcelain-energy heater described herein has much greater acid and alkali resistance than metal heaters.
7. High strength: The anti-fracture strength of the porcelain-energy heater is greater than 700 Mpa. A calculation result shows that, for a porcelain-energy heater having a heating area of 41 cm² and a power of 1500 W in the water having a temperature of 100□, fracture does not occur under the pressure of 50-60 Mpa.

When introducing elements of the heater according to the several embodiments, the articles “a”, “an”, “the” and “said” are intended to mean that there are one or more of the elements. The terms “comprising”, “including” and “having” are intended to be inclusive and mean that there may be additional elements other than the listed elements. Moreover, the use of “up” and “down” and variations of these terms is made for convenience, but does not require any particular orientation of the components. Furthermore, “bottom” and “up” as used herein are not meant to limit the scope of the invention. They are relative terms used to indicate relationship of parts disclosed herein.

As various changes could be made in the above without departing from the inventive concept described herein, it is intended that all matter contained in the above description and shown in the accompanying drawing shall be interpreted as illustrative and not in a limiting sense.

What is claimed is:

1. A porcelain-energy heater comprising:
a heat source electrically connected with lead pins; and
an insulation material enclosing the heat source therein, the insulation material being made of a porcelain material.

2. The porcelain-energy heater of claim 1, wherein the porcelain material includes one or more of silicon nitride, titanium nitride, aluminum nitride, and aluminum oxide.

3. The porcelain-energy heater of claim 1, wherein the heat source is made of alloy electric heating wire and/or tungsten wire, and the insulation material and the heat source are joined by a hot-pressing sintering process

4. The porcelain-energy heater of claim 3, wherein the alloy electric heating wire is made of nickel-chromium resistance wire.

5. The porcelain-energy heater of claim 1, wherein the heat source comprises a plurality of sub-heat sources.

6. A porcelain-energy heater comprising:
a heat source configured to produce heat; and
an insulation material enclosing the heat source, the insulation material being made of a porcelain material and directly contacted with the heat source.

7. The porcelain-energy heater of claim 6, wherein the porcelain material is selected from the group consisting of silicon nitride, titanium nitride, aluminum nitride, and aluminum oxide.

8. The porcelain-energy heater of claim 6, wherein the insulation material and the heat source are joined by a hot-pressing sintering process.

9. The porcelain-energy heater of claim 6, wherein the heat source is configured to receive electricity to produce heat from electricity.

10. The porcelain-energy heat of claim 9, wherein the heat source is made of alloy electric heating wire and/or tungsten wire.

11. The porcelain-energy heater of claim 10, wherein the alloy electric heating wire is made of nickel-chromium resistance wire.

12. The porcelain-energy heat of claim 6, wherein the heat source comprises a plurality of sub-heat sources each directly contacted with the insulation material.
